(19) United States
(12) Patent Application Publication
(10) Pub. No.: US 2010/0102167 A1
(43) Pub. Date: Apr. 29, 2010

(54) LANDING WHEEL GEAR

(76) Inventor: Shaul Dital, Haifa (IL)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/521,893

(22) PCT Filed: Sep. 23, 2007
(86) PCT No.: PCT/IL07/01166

§ 371 Date: Jul. 1, 2009

(51) Int. Cl. B64F 1/02; B64F 1/10

(52) U.S. Cl. 244/110 E

(57) ABSTRACT

A Separate and mobile landing gear which substitutes the existing fixed landing gear in aircrafts. This innovated landing gear locks on the landing aircraft in the manner described in the detailed description.

### FIELD OF THE INVENTION

Aviation & Space.

### BACKGROUND OF THE INVENTION

This invention separates the landing gear from the aircraft. Currently the landing gear is an integral and inseparable part of the aircraft.

### SUMMARY OF THE INVENTION

A separate independently mobile appliance which is planned to serve as the landing gear to the returning space shuttle/aircraft. The appliance locks onto the bottom of the space shuttle/aircraft as described later.

### BRIEF DESCRIPTION OF THE FIGURES

FIG. 1 Illustrates a side view of the space shuttle/airplane with separate landing gear attached to it.

FIG. 2 Illustrates a top view on the landing gear including details of parts of the upper and lower structure.

### DETAILED DESCRIPTION OF PREFERRED EMBODIMENTS

The basic idea is providing an alternative or additional possibility of landing an aircraft using landing gear which is not an integral part of the aircraft. The purposed landing gear is made of a system of motor and steering which operate independently, guided along the runway while locking on the “plane that ordered” it for attachment (in case of landing), as well as to taxi the taking off aircraft up to its disengagement.

From there the landing gear will return to provide an identical service to another aircraft—whether taking off or landing.

All this items are suitable for space shuttle as well.

Advantages

This invention enables, first and foremost, the safe landing of an aircraft when its landing gear fails to open.

Furthermore, it is possible to use this invention as a substitute for landing gear. This will save large sums of money in the building of aircrafts as well as tons in weight. (4-6 tons depends on the type of the aircraft, passenger aircraft/cargo carrier/space shuttle).

Safety is another advantage which is due to the mechanical simplicity of the appliance and the possibility to replace it with another in case of problems while operating it.

An Aerodynamic Improvement: a smooth structure of the aircraft.

No doubt, the cost of maintenance of some of the aircrafts will be reduced when the system is used as complete substitute.

Operation and General Structure

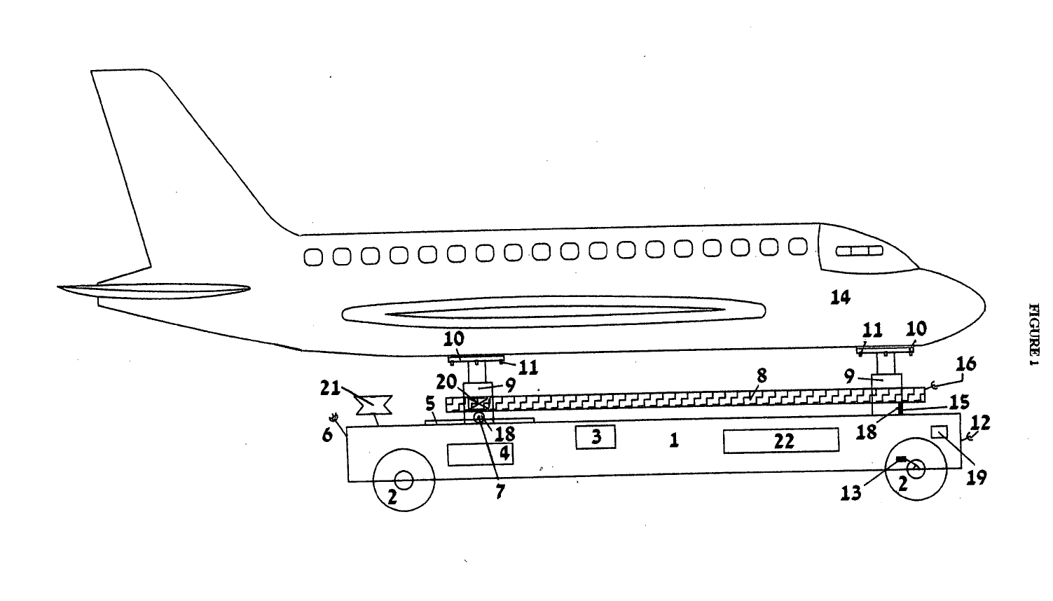

The independent mobile landing gear is made of a system of wheels (part 2 FIG. 1, 2), motor (part 4 FIG. 1, 2) and transmitter, as well as double steering (part 13 FIG. 1) which also operates simultaneously the back wheels. All of it has advantages that will be clarified later. The steering system and the motor are controlled by computerized navigation system based on G.P.S (Global Positioning System) that receive the location data of the aircraft and the landing gear and hence operate accordingly the motor and steering in order to link with the landing aircraft (parts 3, 12, 6 FIG. 1, 2). The attachment (linkage) between the landing gear and the aircraft will be done based on the method of attachment in vacuum surfaces and/or “plug—socket” (parts 10, 1 FIG. 1, 2) while the plugs and/or the suction surfaces/vacuum are on the landing gear and the sockets and/or the attachment surfaces are on the aircraft's underbelly. This plugs and suction surface will be installed on a set of beams attached by axis to the landing gear (part 8 FIG. 1, 2).

This system will perform the final guidance towards the sockets/surfaces on the body of the aircraft (part 14 FIG. 1). This is required because of the fact that aircraft lands with its “nose to the wind” and not necessarily parallel to the runway. This method will do away with the need to correct “heading” of the aircraft towards its touchdown on the runway and so “heavy landings” will be avoided, in the case of side wind there is another clear advantage to the system. Obviously the location of the plugs/surfaces on the set of beams changes according to the type of the “aircraft that orders” (part 20 FIG. 1, 2). The matter of the double steering (part 19 FIG. 1, 2) mentioned earlier is not necessary but is most useful. Such steering will enable fast maneuvering/faster moving of the aircraft to the service lane and the runway will be cleared for take off and landing.

It should be clear that the “mobile landing gear” moves towards the aircraft and not the other way round, the aircraft's landing process does not change.

E) Explanation of Drawings

The drawings describe the system from general structure of the landing gear, the navigation and guidance system. The items are numbered and explained.

The drawings are made of two parts:

FIG. 1: Top view of the landing gear.

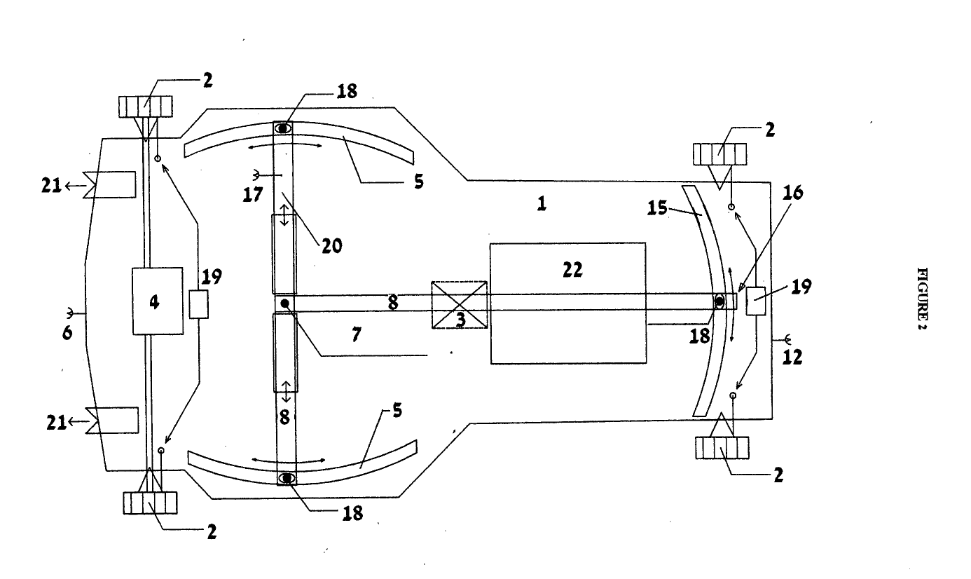

FIG. 2: Side view describing the mobile landing gear and how the aircraft is attached to it.

Carrying out the Invention
1. The general design will be done by mechanical, electronics, computer and aeronautical engineers, using computer simulation.
2. Detailed Planning Includes All Experts: mechanical, aeronautic, computer and communication in order to complete the manufacturing file.
3. The building of a prototype and carrying out a series of tests to detect malfunctions and shortcomings.
4. The building of a product and/or a series of test products and to operate them in the framework of final tests.

Comment:

The construction of the device does not require the search for new solutions, all the technologies already exist and the detailed planning will incorporate them in the new device as described in the above pages.

### DETAILED DESCRIPTION ACCORDING TO ITEM NUMBERS SEE FIGS. 1-2

1. Main chassis.

2. Wheels—4 units—double or as required.

3. Main computers.

4. Main engine.

5. Rear monorail for directing upper carrier.

6. Reception antenna for rear—plane location point.

7. Rotation axis for upper carrier.

8. Upper carrier adjustable according to plane heading and telescopic—according to plane type.

9. Piston carrying attachment surface.

10. Attachment surface vacuum and/or plugs.

11. Vacuum pumps.

12. Front antenna to home in on target for location on runway axis.

13. Steering engine+hydraulic system.

14. Plane.

15. Monorail directing of upper carrier adjustable to heading of plane.

16. Front antenna of upper carrier for final adjustment according to heading of plane.

17. Rear antenna—as maintained above.

18. Front wheel and rear wheel for upper carrier.

19. Hydraulic pump for steering.

20. Telescopic system of upper carrier for adjustment according to plane type.

21. Jet A.P.U—Auxiliary Power Unit.

22. Fuel Tanks.

1. A landing gear system for landing an aircraft, the system comprising:
a motorized wheeled chassis;
an anchoring device disposed on the chassis and configured to securely attach to a bottom of the aircraft, wherein the anchoring device includes a vacuum cap; and
a navigator device configured to navigate the chassis such that it moves in synchrony with and beneath the aircraft as the aircraft descends for landing;
wherein the anchoring device is configured to securely anchor the aircraft to the chassis, and
wherein the chassis is configured to slow down and bring the aircraft to a halt.

2. The system as claimed in claim 1, wherein the anchoring device is positioned on an upper carrier platform provided on the chassis, the platform provided with an aligning mechanism for aligning with the heading of the aircraft.

3. The system as claimed in claim 1, wherein the anchoring device comprises at least one height-adjustable pole.

4. (canceled)

5. The system as claimed in claim 1, wherein the anchoring device comprises an adjustable attachment configured to have an adjustable width and length so as to fit aircraft of different sizes.

6. The system as claimed in claim 1, wherein the navigator is onboard the chassis.

7. The system as claimed in claim 1, wherein the navigator is a GPS based device.

8. A method for landing an aircraft, the method comprising:
providing a landing gear system for landing an aircraft, the system comprising a motorized wheeled chassis that includes an anchoring device that includes a vacuum cap that is configured to securely attach to a bottom of the aircraft;
navigating the chassis, using a navigation device, such that the chassis moves in synchrony with and beneath the aircraft as the aircraft descends for landing; and
securely attaching the aircraft to the chassis using the vacuum cap.

9. The method as claimed in claim 8, further comprising aligning the anchoring device with the aircraft as it descends over the chassis.

10. The method as claimed in claim 9, wherein the step of aligning the anchoring device with the aircraft as it descends over the chassis includes aligning an upper platform disposed on the chassis with the aircraft.
